(19) United States
(12) Patent Application Publication
(10) Pub. No.: US 2007/0036596 A1
(43) Pub. Date: Feb. 15, 2007

(54) Multifunction machine system and paper feed control method in the multifunction machine system

(75) Inventor: Tomohiro Takahashi, Nagano-ken (JP)

Correspondence Address: EDWARDS & ANGELL, LLP, P.O. BOX 55874, BOSTON, MA, 02205, US

(73) Assignee: Seiko Epson Corporation, Tokyo (JP)

(21) Appl. No.: 11/494,135

(22) Filed: Jul. 26, 2006

(30) Foreign Application Priority Data
Jul. 28, 2005 (JP) 2005-218840

(51) Int. Cl. G03G 15/00

(52) U.S. Cl. 399/381

(57) ABSTRACT

The present invention is directed to a multifunction machine system which is provided with, a scanner section which executes a reading process to read an original document and generate image data, a memory section in which the image data thus obtained is stored temporarily, a printer section which executes a paper feed process to feed print paper, generates print data based on the image data and performs printing onto the print paper thus fed, thereby executing a copying process as to the original document, and a control means which accepts a setting of a copy mode, wherein, when the copy mode is set to perform a layout processing which arranges multiple images of the original document as a target for reading, on the print paper according to a size of the original document being detected, the control means controls so that the paper feed process is performed after the reading process is completed, and when any other copy mode is set, the control means controls so that the paper feed process is performed before the reading process is completed. With this configuration above, paper feeding can be performed at the timing appropriate for the copy mode, while reducing the processing time of the copying process.

### BACKGROUND OF THE INVENTION

The present invention relates to a multifunction machine system.

In recent years, a scanner-integrated printer (SPC multifunction apparatus) is becoming widespread, which is provided with multiple functions such as scanner function (Scanner), printer function (Printer), and copy function (Copy).

The SPC multifunction apparatus (multifunction machine) is provided with a scanner section which performs a process to read an image from an original document, a printer section which performs a process to print the image onto a print medium, and a memory in which the image data read by the scanner section is temporarily stored.

The scanner section is provided with an exposure lamp serving as a light source for illuminating the original document placed on a document glass, and a sensor (linear image sensor) on which photodiodes are placed in a row to detect light reflected from the original document. The scanner section moves the sensor in a direction (sub scanning direction) perpendicular to the direction (main scanning direction) along which the sensor is arranged, and stores in the memory as image data, color information of reflected light which has been detected. Then, the scanner section converts the image data stored in the memory into print data, and the printer section executes printing process onto the paper being fed, on the basis of the print data, thereby achieving a stand-alone copying function which performs copying process without involving a host computer.

As thus described, in the copying process, the image read process, print data conversion process, paper feed process, and printing process are carried out. Regarding a timing control in each of the above processes, Japanese Patent Laid-open Publication No. 2004-128896 discloses that the image read process is started after the paper feed process is completed. According to the control above, even when a carrier system error occurs such as paper jam or paper out during paper feeding, the image read process is started after a recovery from the carrier system error. Therefore, it is possible to obtain an evenness of color and continuity of copy result, even when the light quantity illuminated from the light source is varied while the image read process is suspended.

However, since the paper feed process is independent from the image read process those processes are essentially able to be carried out in parallel. In the case above, the image read process is started after the paper feed process is completed, and thus processing time for the copying process is required additionally.

From the viewpoint of reducing the processing time for the copying process, it is desirable that the paper feed process and the image read process are started at the same time, and they are performed concurrently. With the configuration as thus described, it is possible to start printing immediately after the head part of the image data having been read is converted into print data. Subsequently, the image data is converted into print data sequentially while the image is read, allowing a continuous printing.

### SUMMARY OF THE INVENTION

In the mean time, in some kinds of copying process, the image read process and the printing process are not allowed to be performed in parallel. For example, a copy mode referred to as “repeat mode” requires that the image data of the whole original document is temporarily stored in a memory, and an image processing such as layout processing is executed onto the image data, before printing is performed.

Since this kind of copying process performs the layout processing, required time period from the reading start to the printing start is longer, compared to a normal copying process. Therefore, if the paper feeding is started before reading the image data or simultaneously therewith, print paper is kept to be in the feeding status for a certain period of time, before the printing starts.

Generally, in the paper feeding status, the print paper is put in a state of being bent inside the multifunction machine, and if this state continues for a long time, there is a possibility that the print paper takes on a shape of curled. Therefore, it is desirable that the paper feeding status is made as short as possible.

An object of the present invention is to perform paper feeding at the timing appropriate for the copy mode, while reducing the processing time of the copying process.

In order to achieve the object above, a multifunction machine system according to the first aspect of the present invention is provided with,

a scanner section which executes a reading process to read an original document and generate image data,

a memory section in which the image data thus obtained is stored temporarily,

a printer section which executes a paper feed process to feed print paper, generates print data based on the image data and performs printing onto the print paper thus fed, thereby executing a copying process as to the original document, and

a control means which accepts a setting of a copy mode, wherein,

when the copy mode is set to perform a layout processing which arranges multiple images of the original document as a target for reading, on the print paper according to a size of the original document being detected, the control means controls so that the paper feed process is performed after the reading process is completed, and when any other copy mode is set, the control means controls so that the paper feed process is performed before the reading process is completed.

According to the present invention, when the copy mode is set to perform the layout processing which needs longer time from reading start to printing start, the paper feed process is performed after the reading process is completed. Therefore, it is possible to prevent the print paper from being kept in the feeding status for a long period of time. On the other hand, in any other copy mode, it is configured such that the paper feed process is performed before the reading process is completed.

With the configuration above, it is possible to reduce the processing time of the copying process, while allowing the paper feeding to be executed at the timing appropriate for the copy mode.

When the copy mode is set to perform the layout processing, the scanner section performs a tentative reading process to decide an arrangement of the image, before the aforementioned reading process. Even when the copy mode is set to perform the layout processing, if it is determined, as a result of the tentative reading process, that multiple images of the original document are not allowed to be printed on the print paper, the control section may take control of performing the paper feed process before the reading process is completed.

Accordingly, in the case where an arrangement process is not performed even if the copy mode is set to perform the layout processing, it is possible to reduce the copying process time.

In order to solve the above problems, the paper feed control method in a multifunction machine system, according to a second aspect of the present invention is provided with,

a scanner section which executes a reading process to read an original document and generate image data,

a memory section in which the image data thus read is temporarily stored,

a printer section which executes a paper feed process to feed print paper, generates print data based on the image data and performs printing onto the print paper thus fed, thereby executing a copying process as to the original document, the paper feed control method including the steps of,

accepting a setting of a copy mode,

determining whether or not the copy mode is set to perform a layout processing so that multiple images of the original document as a target for reading are arranged on the print paper based on a size of the original document being detected, and

controlling so that the paper feed process is performed after the reading process is completed when the copy mode is set to perform the layout processing, and when any other copy mode is set, the paper feed process is performed before the reading process is completed.

### BRIEF DESCRIPTION OF THE DRAWINGS

FIG. 1 is a perspective view showing an SPC multifunction apparatus.

FIG. 2 is a perspective view showing the SPC multifunction apparatus in a situation in which a cover of scanner section is opened.

FIG. 3A and FIG. 3B are schematic configuration diagrams of the scanner section.

FIG. 4 is a schematic configuration diagram of printer section.

FIG. 5 is a block diagram showing an electric configuration of the SPC multifunction apparatus.

FIG. 6 is an illustration to explain automatic repeat mode copying process.

FIGS. 7A, 7B, 7C, 7D, 7E, and 7F are illustrations to explain read-in image data of an original document and image data.

FIG. 8 is a flow diagram showing a paper feed control process according to the present embodiment.

FIGS. 9A, 9B, and 9C are timing diagrams to explain the paper feed control.

### DETAILED DESCRIPTION OF THE PREFERRED EMBODIMENTS

With reference to the accompanying drawings, preferred embodiment of the present invention will be explained. The present embodiments show examples in which the present invention is applied to a multifunction machine.

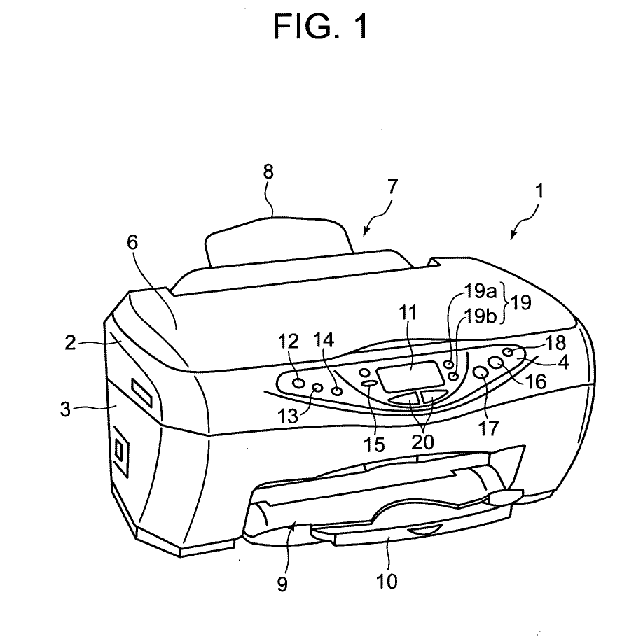

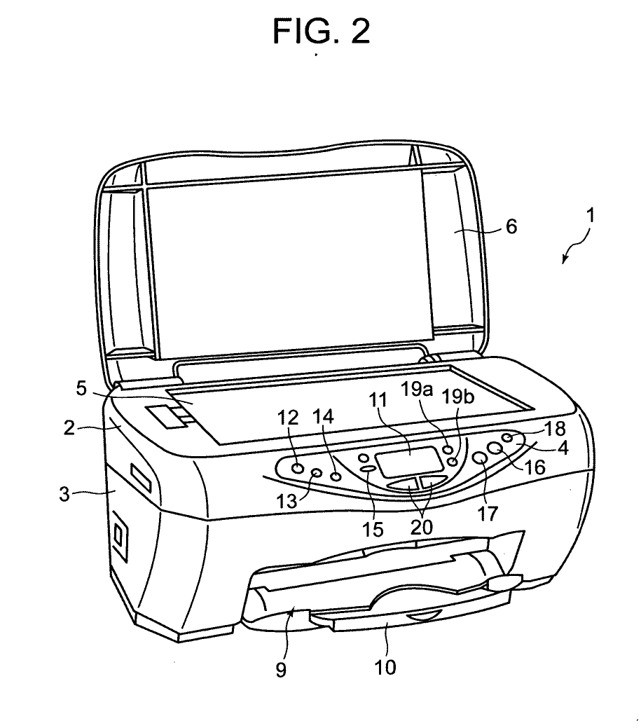

FIG. 1 is a perspective view showing an SPC multifunction apparatus, and FIG. 2 is a perspective view showing the SPC multifunction apparatus in a situation in which the cover of scanner section is opened.

The multifunction machine according to the present embodiment is an multifunction apparatus (hereinafter, also referred to as “SPC multifunction apparatus”), being provided with multiple functions such as a scanning function (Scanner) which executes scanning process according to a scan instruction from a personal computer (hereinafter, referred to as “PC”) a printing function (Printer) which executes printing function according to a print instruction from the PC, and copying function (Copy) which executes copying process on a stand-alone basis in the multifunction machine.

As shown in FIG. 1 and FIG. 2, the SPC multifunction apparatus 1 is provided with scanner section 2 which reads an image of an original document and generates image data, printer section 3 which prints an image based on the image data, on a medium to be printed such as a sheet of paper, and control panel section 4 which is operated by a user. In the SPC multifunction apparatus 1, the image data read by the scanner section 2 is transmitted to the printer section 3, converted into the print data in an internal processing circuit, and an image based on the print data is printed onto a sheet of paper, thereby achieving a stand-alone copying function.

The scanner section 2 is arranged above the printer section 3, and on the upper portion of the scanner section 2, there are provided an A-4 size document glass 5 to place an original document to be read, and a document glass cover 6 which covers the document glass 5 when the original document is being read or when the apparatus is not in use. The document glass cover 6 is formed in such a manner as openable and closable, and when it is closed, this cover also functions to press the original document towards the document glass 5, on which the original document is placed.

On the rear side of the SPC multifunction apparatus 1, there is provided a paper supply section 7 which supplies paper to the printer section 3, and the paper supply section 7 is further provided with a paper feed tray 8 to hold a A-4 size cut paper or the like. On the lower part of the front side of the SPC multifunction apparatus 1, there is provided a paper eject section 9 which ejects paper printed in the printer section 3, and this paper eject section 9 is provided with an ejected paper tray 10 which is capable of closing the paper ejection port when the apparatus is not in use. The control panel section 4 is provided above the paper eject section 9.

The control panel section 4 has a function allowing a user to directly operate the SPC multifunction apparatus 1, and there is provided a liquid crystal display 11 at approximately the center thereof. The liquid crystal display 11 is capable of displaying set items, setting status, or operation status, using characters, as well as displaying the image read by the scanner section 2. In the status as shown in FIG. 1 and FIG. 2, on the left side of this liquid crystal display 11, there are provided a power button 12, a scan button 13, a setting-display button 14, and clear button 15.

The power button 12 is a button which turns the power to the SPC multifunction apparatus 1 ON and OFF. The scan button 13 is a button to allow the scanner section 2 to start reading the original document. The setting-display button 14 is a button to allow the liquid crystal display 11 to display a status of settings for the copy function, which have been set by the user. The clear button 15 is a button to clear the settings for the copy function, in order to change each set item to a default value.

In the state as shown in FIG. 1 and FIG. 2, on the right side of this liquid crystal display 11, there are provided a color copy button 16, a monochrome copy button 17, a stop button 18, and number-of-copies-setting buttons 19 (19a, 19b). The color copy button 16 is a button to start color copying, and the monochrome color button 17 is a button to start monochrome copying. Therefore, these copy buttons 16 and 17 function as both instructing means to start the copy operation and selecting means for selecting whether the print image to be outputted is in color or monochrome.

In addition, the color copy button 16 also serves as a notifying means with which the user notifies the SPC multifunction apparatus 1 of a recovery from carrier system error, when the printing process (copying process) is suspended due to the carrier system error, such as paper out and paper jam, for example. The stop button 18 is a button to stop copying operation, which has already started. The number-of-copies-setting buttons 19 are made up of two buttons 19a, 19b, having “+” and “−” respectively written on their surfaces. By pressing the “+” button 19a, the setting of the number of sheets increases, and by pressing the “−” button 19b, the setting of the number of sheets decreases.

On the front side of the liquid crystal display 11, there are provided menu buttons 20 which change the set items displayed on the liquid crystal display 11. The menu buttons 20 are made up of two buttons arranged on the right and left, having a rightward arrow or a leftward arrow written thereon, respectively. Every time either the right or left one of the menu buttons 20 is pressed, the displayed set items sequentially change according to a predetermined order, and after all the items have been displayed once, the first set item is displayed again. The left and right arrows are for changing the order in which the setting items are displayed, and each button 20 allows the set items to be displayed in the order opposite to the displaying order for when the other button is pressed.

It is to be noted that the liquid crystal display 11 also displays a menu screen which is used to set a quality of the copying process (copy quality mode) with respect to each type of print paper P (for example, glossy paper used for photo, plain paper, or the like). The user operates the menu buttons 20 while referring to the liquid crystal display 11, thereby allowed to select a copy quality mode to obtain a copy image of desired quality.

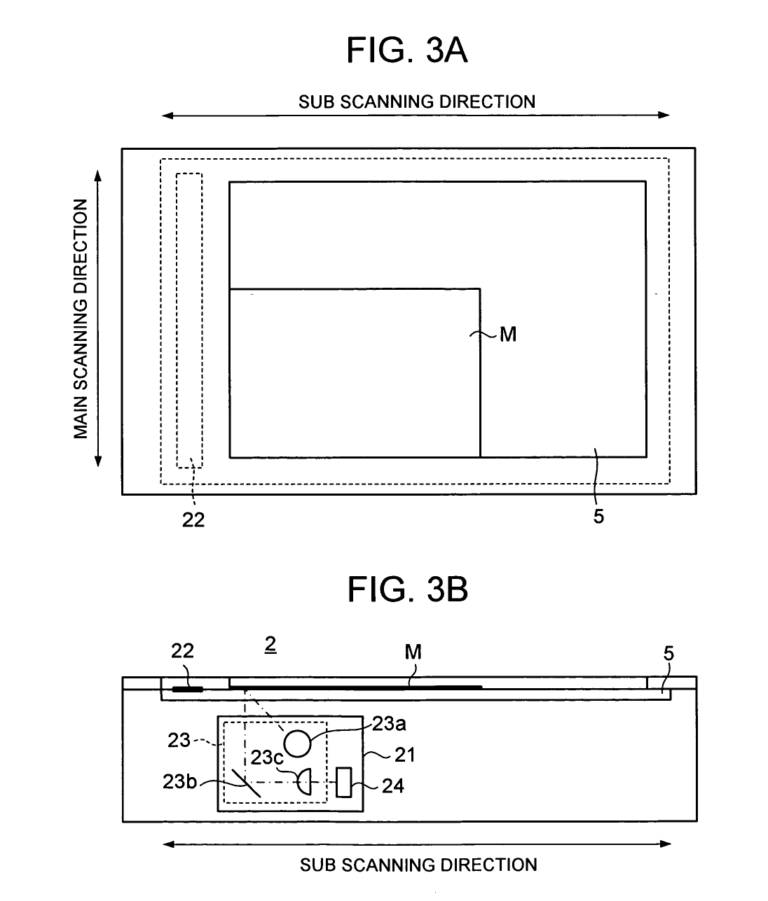

Next, with reference to the schematic diagrams as shown in FIG. 3A and FIG. 3B, the scanner section 2 will be explained in detail. It is to be noted that FIG. 3A is a plan view and FIG. 3B is a side view.

As shown in FIG. 3A and FIG. 3B, the scanner section 2 is provided with a document glass 5 in a form of plate having approximately rectangular surface on which the original document M is placed, and a read carriage 21 which is disposed in such a manner as opposed to the original document M, interposing the document glass 5 therebetween in the board-thickness direction of the document glass 5.

On the inner periphery of one end of the document glass 5 in the longitudinal direction, a white reference plate 22 in a form of rectangular plate, is disposed in such a manner as extending in the width direction of the document glass 5.

The read carriage 21 is accommodated under the document glass 5, in such a manner as reciprocable in the longitudinal direction thereof, and guided to be moved in parallel with the document glass 5 according to a guide shaft or the like, not illustrated, which is disposed in parallel with the document glass 5. The read carriage 21 is provided with an optical system 23 and a linear image sensor 24. The optical system 23 and the linear image sensor 24 are placed in the longitudinal direction of the read carriage 21, and they are carried in the longitudinal direction of the document glass 5 by means of the read carriage 21.

In the following explanation, the longitudinal direction of the read carriage 21 is assumed as a main scanning direction in the scanner section 2 (see FIG. 3A), and the longitudinal direction (a direction perpendicular to the main scanning direction) of the document glass 5 is assumed as a sub scanning direction (see FIG. 3B).

The optical system 23 includes a light source 23a, a mirror 23b, an image formation lens 23c, and so forth. For example, the light source 23a is a white cathodoluminescent lamp, and it is equipped in the read carriage 21 in a posture that the longitudinal direction axis of the light source extends in parallel with the longitudinal direction axis of the linear image sensor 24. The light illuminated from the light source 23a is reflected off the original document M, and an image is formed on the linear image sensor 24 via the mirror 23b and the image formation lens 23c. The linear image sensor 24 optically reads an image of the original document placed on the document glass 5, converts the image to electric charge, and stores it.

Every time when the copying process is started, illuminated light is applied to the white reference plate 22 from the light source 23a, and the light reflected from the white reference plate 22 is detected by the linear image sensor 24, thereby measuring the light quantity of the light source 23a.

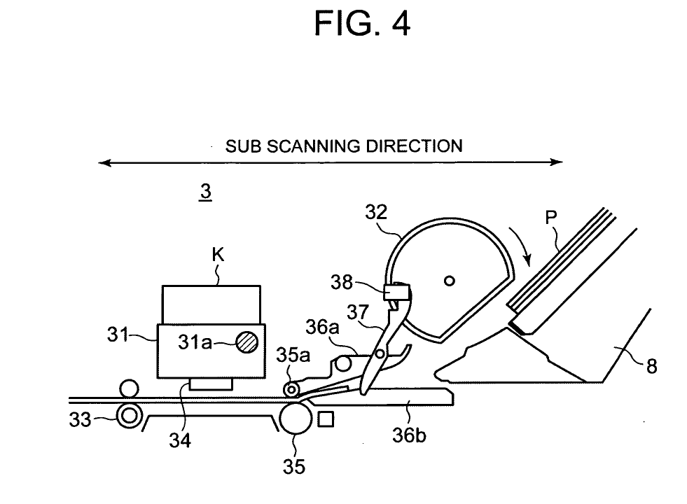

Next, with reference to FIG. 4, the printer section 3 will be explained in detail. FIG. 4 is a side view showing a schematic configuration of the printer section 3.

As shown in FIG. 4, the printer section 3 is provided with a write carriage 31 which discharges ink onto the print paper P as a medium to be printed, a paper feed roller 32 which feeds the print paper P to the write carriage 31, and a paper eject roller 33 which ejects the print paper P from the write carriage 31. In the present embodiment, the printer section 3 employs the ink-jet method which forms an image by discharging ink drops onto a medium such as print paper.

The write carriage 31 is disposed in a reciprocable manner along the guide member 31a, the guide member being installed in such a manner that it extends in the direction approximately perpendicular to the direction in which the print paper P is carried by the paper feed roller 32 and a carriage roller 35 (left direction in the state as shown in FIG. 4) It is to be noted here, in the printer section 3, the direction in which the write carriage 31 reciprocates (the direction perpendicular to the longitudinal paper surface) is assumed to be main scanning direction, and the direction to which the print paper P is fed (the direction perpendicular to the main scanning direction) is assumed to be sub scanning direction.

The write carriage 31 has a nozzle (not illustrated) to discharge ink drops, and it is provided with a recoding head 34 being disposed at the lower part of the write carriage 31 and ink cartridge K.

The ink cartridge K is filled with ink of four colors, cyan (C), magenta (M), yellow (Y), and black (K). By discharging colored ink from the nozzles of the recording head 34 to the print paper, the printer section 3 outputs a color image. In addition to the four colors above, light cyan (LC), light magenta (LM) and dark yellow (DY) may be used as the color ink.

The paper feed roller 32 rotationally operates and carries one by one, the sheet of print paper P which is set in the paper feed tray 8 towards the write carriage 31 side. On the downstream side in the feeding direction of the paper feed roller 32 (on the left side in the state as shown in FIG. 4), there are arranged the carriage roller 35, and a pair of guides 36a, 36b, which are disposed between the carriage roller 35 and the paper feed roller 32, to guide the print paper P.

The carriage roller 35 pairs up with a driven roller 35a which follows the rotation of the carriage roller 35, and holds therebetween the print paper P having been supplied by the paper feed roller 32. The print paper P is carried toward the position below the write carriage 31 through the rotational operation of the carriage roller 35 and the driven roller 35a.

The guides 36a and 36b are provided with a lever 37 and a paper detection sensor 38 in the vicinity of the paper entry. The lower end of this lever extends with a length reaching the path through which the paper is carried, and the paper detection sensor 38 detects the upper end of the lever 37. The paper detection sensor 38 is turned ON, when the print paper P being fed presses the lower end of the lever 37 and makes the lever to rotate. The paper detection sensor 38 is turned OFF, when the rear end of the print paper P which is pressing the lower end of the lever 37 has passed through and the lever 37 returns to the original position (restores to the original position) by a spring. In other words, the paper detection sensor 38 is capable of detecting a carrier system error such as print paper out.

The paper eject roller 33 is installed in the downstream of the write carriage 31. The paper eject roller 33 cooperates with the carriage roller 35, and carries the print paper P by rotational operation. At the time of paper feeding, the carriage roller 35 and the paper eject roller 33 eject the previous print paper P, and simultaneously, the paper feed roller 32 and the carriage roller 35 feed the next print paper P.

The write carriage 31 performs reciprocating operation in the main scanning direction on the print paper P which is carried by the paper feed roller 32, the paper eject roller 33, and the carriage roller 35, thereby setting the position of the record head 34 with respect to the print paper P. The record head 34 being disposed at a predetermined position discharges ink drops, thereby forming dots on the print paper P, and then printing is performed. The print paper being printed is carried towards the downstream side (the left side in FIG. 4) of the write carriage 31 by the rotation of the carriage roller 35 and the paper eject roller 33, and then, it is ejected from the paper eject section 9 (see FIG. 1 or FIG. 2).

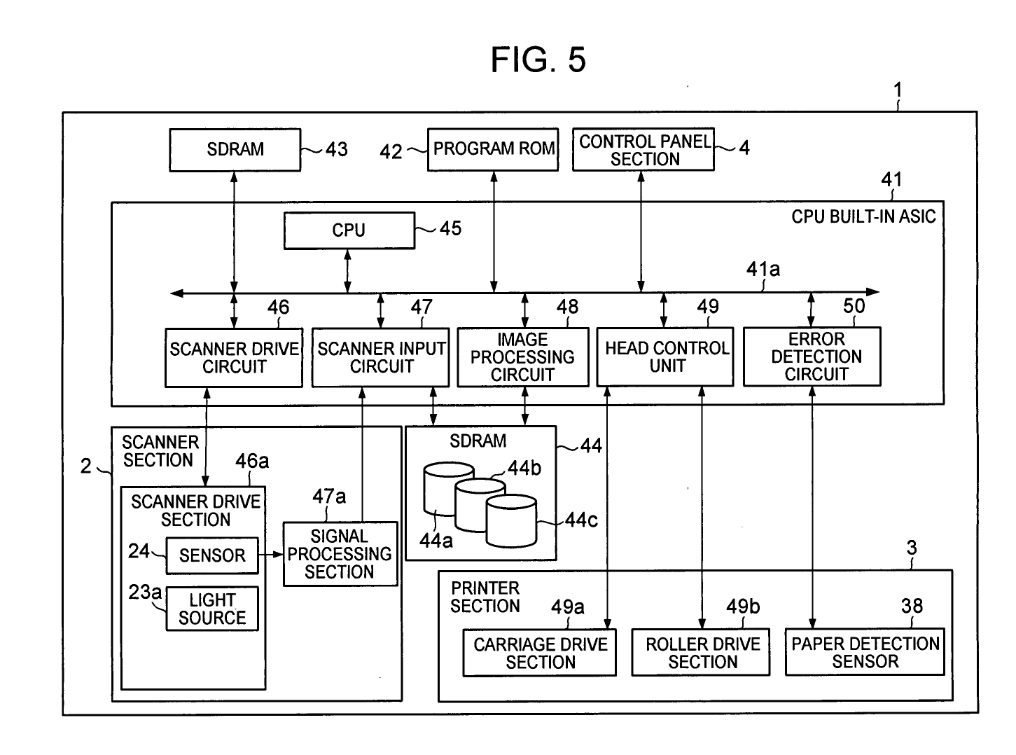

FIG. 5 is a block diagram showing electric configuration of the SPC multifunction apparatus 1. FIG. 5 illustrates a circuitry to implement copying function. Therefore, an interface circuit, processing circuit, and the like, which are required for the functions as a printer and/or a scanner with connection to a personal computer (PC), or the like, are omitted.

The SPC multifunction apparatus 1 is provided with a main substrate (not illustrated) which performs overall control in the printer section 3 case. This main substrate is equipped with a CPU built-in ASIC (Application Specific IC) 41, program ROM 42, the first SDRAM 43, the second SDRAM 44, and the like.

The ASIC 41 is externally equipped with the program ROM 42, the first SDRAM 43, and the control panel section 4, and those components are connected to the internal bus 41a on the ASIC 41. Furthermore, the ASIC 41 contains CPU 45, scanner drive circuit 46, scanner input circuit 47, image processing circuit 48, head control unit 49, and error detection circuit 50, which are connected to the internal bus 41a.

The program ROM 42 stores control programs and the like, which are executed by the CPU 45. The image data read by the scanner section 2 and the print data printed by the printer section 3 are temporarily stored in the first SDRAM 43. The second SDRAM 44 is connected to the scanner input circuit 47 and the image processing circuit 48, and functions as a memory section in which image data and/or print data before and after the processing performed in each of the circuits 47 and 48 are temporarily stored. Line buffer 44a, Micro Weave buffer 44b, and image buffer 44c are each allocated to the memory region of this second SDRAM 44.

CPU 45 is an operation unit, and executes the control programs stored in the program ROM 42. The CPU 45 controls the scanner section and the printer section 3 based on the control programs stored in the program ROM 42, thereby executing each the processes, such as reading process and printing process.

The scanner drive circuit 46 has a function to drive each mechanism in the scanner section 2, and it is connected to scanner drive section 46a, such as a motor, which drives the read carriage 21 in the scanner section 2. The scanner drive section 46a operates the read carriage 21 and the light source 23a, so as to read the image of the original document along the main scanning direction, and simultaneously transfers the read carriage 21 in the sub scanning direction. The scanner drive section 46a operates the read carriage 21 based on a signal from the scanner drive circuit 46, whereby two-dimensional image data of the original document M placed on the document glass 5 can be read by the scanner section 2.

The scanner input circuit 47 is connected to the signal processing section 47a of the scanner section 2. The signal processing section 47a is provided with A/D translate circuit (not illustrated), which executes A/D conversion process on the electric charge accumulated in the linear image sensor 24 included in the read carriage 21. The data to which the A/D conversion has been applied is subjected to various digital conversion process such as shading correction, gamma correction, pixel interpolation, and the like, and thus processed data is inputted into the scanner input circuit 47 in the ASIC 41.

It is to be noted that the shading correction is to correct a shading caused by the reasons, such as sensitivity variation in each photoelectric transducer of the linear image sensor 24 and/or distribution of the illuminated light quantity in the main scanning direction of the light source 23a. The shading correction is carried out by using a white reference value obtained by reading the white reference plate 22.

Under the control of the CPU 45, the scanner input circuit 47 temporarily stores each raster line data item (multiple tone image data of RGB), which are inputted from the scanner section 2, in the line buffer 44a of the second SDRAM 44. Then, the scanner input circuit 47 sequentially executes interline correction process onto the RGB data captured into this line buffer 44a, and transfers the processed data to the image processing circuit 48 as RGB data for the same line. It is to be noted here that interline correction processing is a process for correcting the misalignment among the reading positions for the R, G, and B linear sensors, which occurs due to the structure of the scanner section 2.

The scanner input circuit 47 also performs, in parallel with the interline correction process, a resolution converting process which converts the resolution for reading RGB data [dpi] into print resolution [dpi] which is used by the printer section 3 to perform printing. In other words, when the resolution for reading the RGB data is lower than the print resolution, linear interpolation or the like is performed to newly generate data between the adjacent data items. On the other hand, when the resolution for reading RGB data is higher than the print resolution, the data may be thinned out at a constant rate, for example, so that the resolution of the RGB data is adjusted to the print resolution. The procedure above is similarly performed also in the case of enlarging copy or reducing copy.

The CPU 45 controls the scanner drive circuit 46 and the scanner input circuit 47 to execute the reading process in the scanner section 2.

The image processing circuit 48 captures the image data having been subjected to the resolution converting process, and executes image processing such as color conversion processing, halftone processing, and Micro Weave processing. The color conversion processing is a process to convert the multiple tone image data of RGB into multiple tone image data of four-color CMYK. The halftone processing is a process to convert the multiple tone image data into area coverage modulation data. The Micro Weave processing is a process to adjust a method for forming dot lines so as to prevent banding between lines.

In this image processing circuit 48, the data having been subjected to the Micro Weave processing is stored in the Micro Weave buffer 44b. Furthermore, the image processing circuit 48 reads data which is stored in the buffer 44b every predetermined size, sorts those data items based on various information (for example, number of nozzles with respect to each color, and head scanning number of times, and the like) and then the sorted data items are transferred to the image buffer 44c. As a result of this data transfer, the image buffer 44c stores head drive data (print data) to allow each nozzle to discharge ink with respect to each scanning by the write carriage (illustration omitted), which is mounted on the printer section 3.

The CPU 45 reads the head drive data (print data) with respect to each scanning, which is stored in the image buffer 44c, and the data thus read out is transferred to the head control unit 49. When the head control unit 49 performs printing on the print paper based on the print data, copy printing as to the image being read by the scanner section 2 is accomplished.

The head control unit 49 is connected to the carriage drive section 49a and the roller drive section 49b of the printer section 3.

The carriage drive section 49a includes a motor which makes the write carriage 31 to slide in the main scanning direction along the guide member 31a, a mechanism which makes the nozzles of the record head 34 to discharge ink drops, and the like.

The roller drive section 49b is a mechanism which functions to carry the print paper P in the sub scanning direction, including the paper feed roller 32, paper eject roller 33, and carriage roller 35. Under the control by the CPU 45, the head control unit 49 drives the carriage drive section 49a and the roller drive section 49b based on the head drive data, moves the write carriage 31 to a predetermined position, and controls whether the ink drops should be discharged or not, as well as controlling the quantity of the ink drops to be discharged.

The error detection circuit 50 is connected to the paper detection sensor 38 of the printer section 3. The CPU 45 determines whether the print paper P is appropriately fed into the record head 34, based on the detection result from the paper detection sensor 38.

Next, automatic repeat mode copying will be briefly explained, as one example of copying process method used in the present embodiment. It is to be noted that details of the automatic repeat mode are described in the Japanese Patent Laid-Open Publication No. 2004-142435.

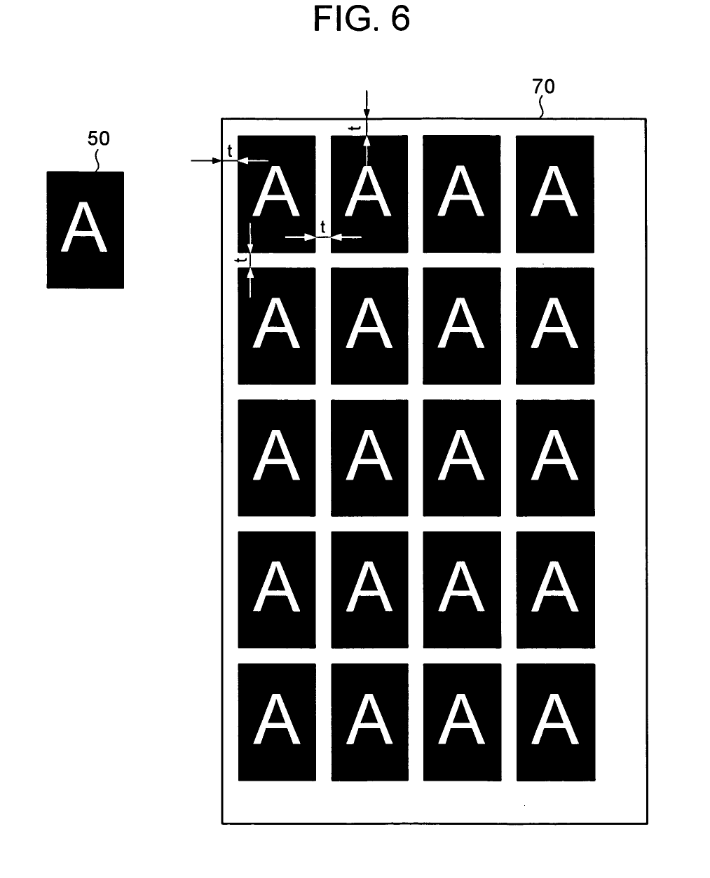

FIG. 6 is an illustration to explain the concept of the automatic repeat mode. In FIG. 6, image “A” is shown on the surface of the original document 50. When the original document 50 is copied by the automatic repeat mode, the number of images “A” is calculated, which are able to be arranged on the print paper, for example having A-4 size, each image having the same size. Then, a printed sheet of paper 70 is obtained, on which the images “A” corresponding to the number of images having been calculated are arranged. In the example of FIG. 6, images “A” are printed in such a manner that five images are arranged longitudinally and four images are arranged laterally, with the space of “t”, that is, 20 (twenty) images in total.

For example, copying according to the automatic repeat mode is carried out in the following procedures. That is, a user places an original document in the SPC multifunction apparatus, and sets up the size of the print paper. Then, the user operates the control panel section 4 so as to instruct the SPC multifunction apparatus 1 to execute the copying process according to the “automatic repeat mode”.

According to this instruction, the scanner section 2 of the SPC multifunction apparatus 1 starts pre-scanning. Pre-scanning is an operation which is performed prior to the main scanning operation to perform printing. This pre-scanning reads images at lower resolution, compared to the resolution of the scanning operation to perform printing.

Then, based on the result of the pre-scanning, an image area is determined. With this determination, it is possible to obtain the size of the original document.

Next, the SPC multifunction apparatus 1 determines the number of images which can be arranged within one sheet of paper, according to the size of the paper and the size of the original document. The number of images is determined as the maximum number which can be arranged on the print paper. The maximum number which can be arranged on the print paper is calculated as (m×n), which is a product obtained by multiplying the maximum number m of images which can be arranged in the longitudinal direction of the paper, and the maximum number n of images which can be arranged in the lateral direction of the paper. It is further possible to present the number of images to the user and obtain confirmation from the user.

Then, the SPC multifunction apparatus 1 performs the main scanning on the image area as a target. The image data of the original document read by the main scanning is stored in the buffer for layout, which is installed in the first SDRAM 43. Therefore, this main scanning is carried out at a resolution which allows the image data of the original document to be stored in the buffer for layout.

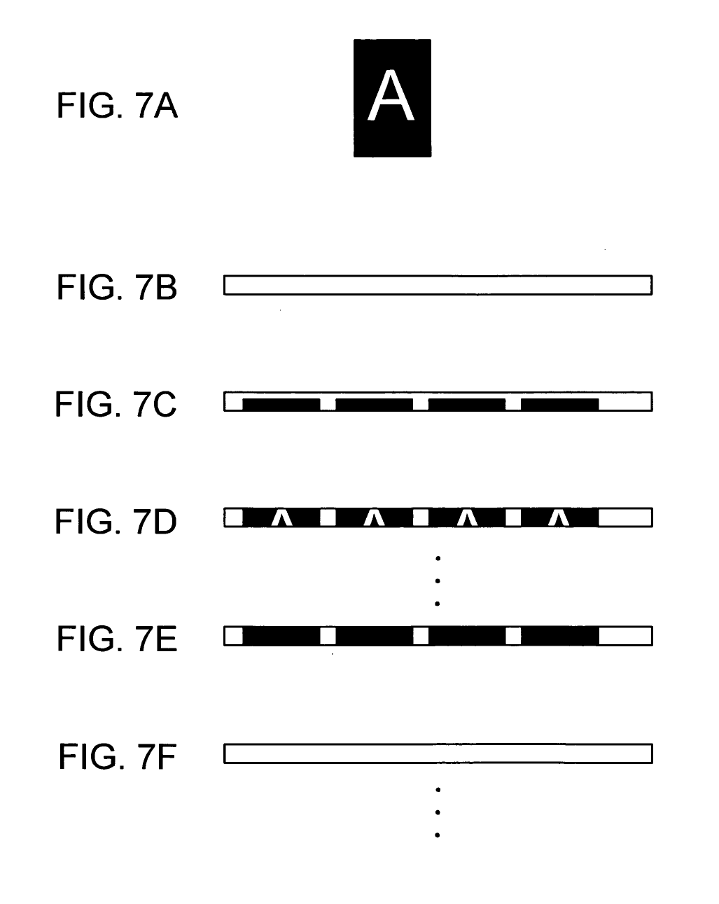

As a result, the image data as shown in FIG. 7A is stored in the buffer for layout. Then, according to the number of the image data items to be arranged on the paper, as shown in FIG. 7B to FIG. 7F, image data is sequentially generated in units of several lines, based on the image data stored in the buffer for layout. These processing steps will be referred to as “layout processing” in the following. The printer section 3 sequentially prints the image data generated by the layout processing, whereby copying process according to the automatic repeat mode is carried out.

As thus described, in the copying process according to the automatic repeat mode, the layout processing including the process to determine the arrangement of the image data must be performed.

In the layout processing, after all the image data of the original document is read in, computing process such as determining the arrangement is performed, and then printing is started. Therefore, compared to the normal copying process in which reading process and printing process can be performed in parallel, longer time is required from the start of reading to the start of printing. Accordingly, if paper feeding is started before or concurrently with reading the image data, the print paper is kept to be in the paper feeding status for a certain period of time, before the printing is started.

As shown in FIG. 4, in the paper feeding status, the print paper P having been set on the paper feed tray 8 is drawn into the paper feed roller 32, and the upper end of the paper waits at a position before the carriage 31. At this timing, the printing paper P is positioned in such a manner that the upper part thereof is on the paper path and the lower part thereof remains on the paper feed tray 8. Therefore, the print paper is bend by the slope of the paper feed tray 8. If this paper feeding status continues for a long time, there is a possibility that the printing paper P takes on a shape of curled. This shape of curled itself does have a direct effect on the printing quality, but it is desirable that the time while the print paper is being bent is made as short as possible.

In view of the above situation, in the present embodiment, the paper feeding time in the copying process is controlled as the following.

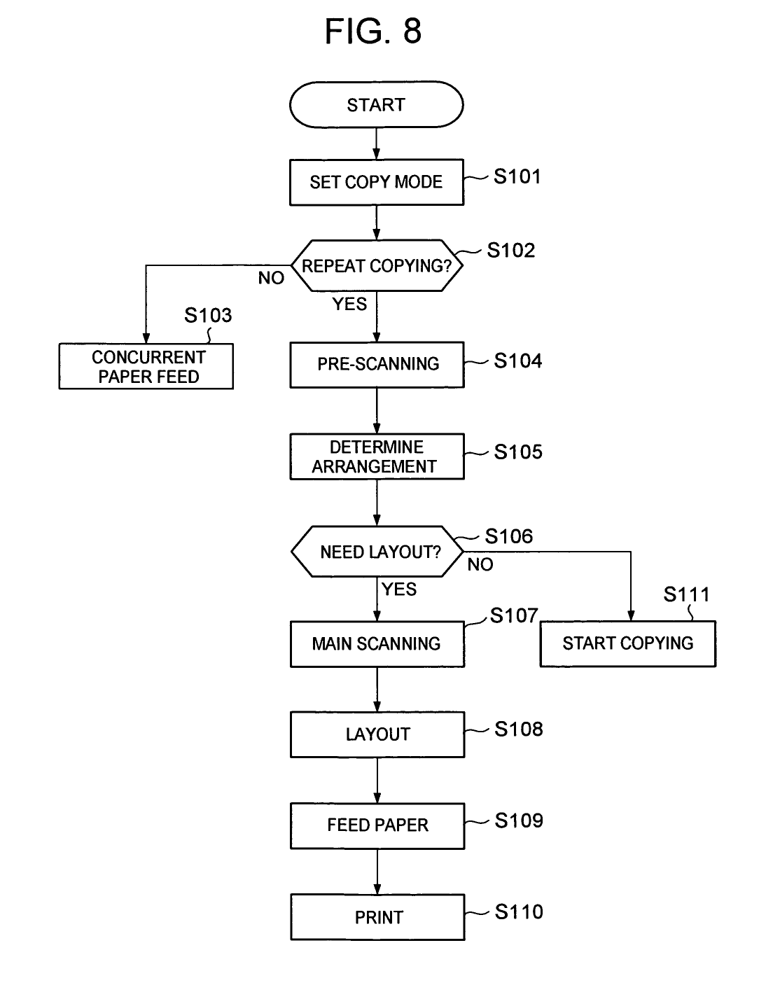

FIG. 8 is a flow diagram to explain a processing which determines timing for paper feed in the copying process according to the present embodiment.

In the copying process, a setting of a copy mode from a user is accepted (S101). Standard copy mode, repeat mode, and N-up mode may be configurable copy mode examples, and detailed settings are available for each mode. For instance, detailed settings are as the following; in the standard copy mode, it is possible to set whether the print is borderless or not, optical disk copying, photograph copying, or the like. In the repeat mode, it is possible to set automatic repeat mode, fixed repeat mode, and the like. In the N-up mode, it is possible to set how many original documents are copied into one page, for instance. Here, it is to be noted that the fixed repeat mode is a mode which makes copies of the read image so that a predetermined number of copies, such as 4, 9, and 16 are arranged on one sheet of paper. Further, it is assumed that the print paper and the original document have already been set by the user.

When the setting of the copy mode is accepted, it is determined whether or not the copy mode being set is “automatic repeat mode” (S102).

As a result, if it is not “automatic repeat mode” (S102: N), concurrent paper feed process is carried out to perform the reading process and the paper feed process concurrently (S103).

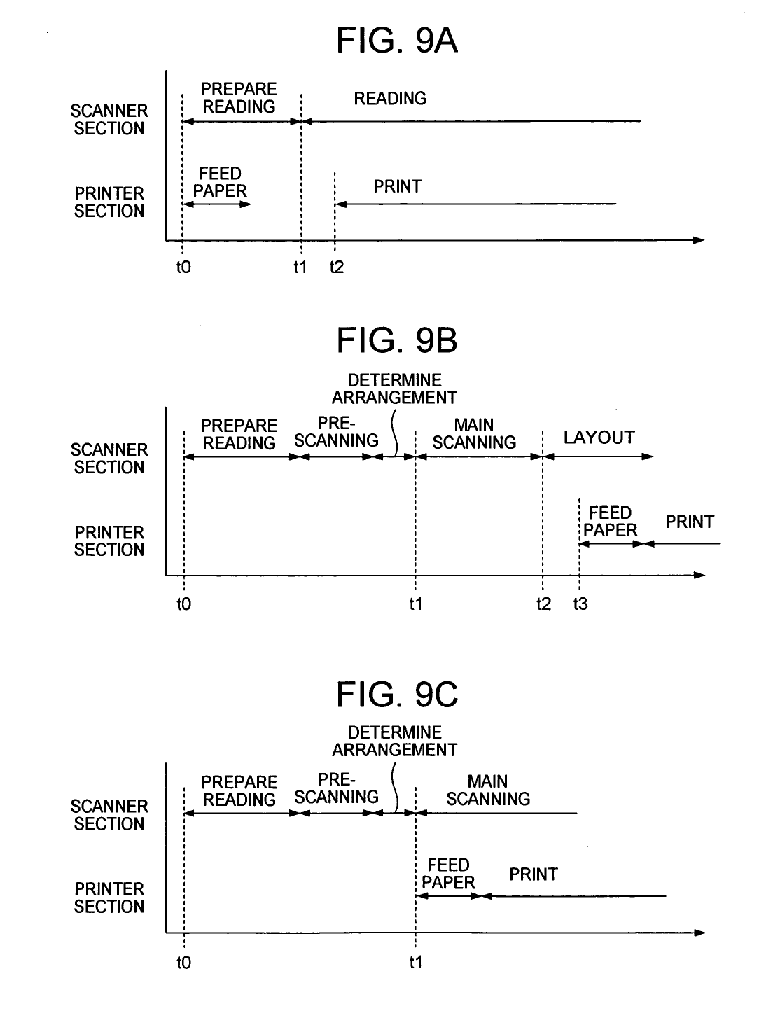

FIG. 9A is a timing diagram to explain the concurrent paper feed process. In the concurrent paper feed process, when the user presses the copy button at the timing of “t0”, reading preparation and paper feeding are started concurrently. Here, when the reading preparation is completed, actual reading is performed (t1) Therefore, immediately after the image is read and print data is generated, printing is started (t2). Accordingly, it is possible to reduce the processing time from the start of reading the print image to the end of copying. It is to be noted that the reading preparation includes calibration process and the like, in which irradiation from the light source 23a is received and the light reflected from the white reference plate 22 is read, thereby obtaining a white reference value.

On the other hand, if the set copy mode is “automatic repeat mode” (S102: Y), pre-scanning is performed without carrying out the paper feeding (S104). Then, based on the size of the original document having been read by the pre-scanning and the paper size set by the user, a processing to determine the arrangement of the image data is performed (S105). FIG. 9B and FIG. 9C are timing diagrams to explain the paper feed process in the automatic repeat mode.

Here, there may be a case that in the processing to determine the arrangement, multiple images are not able to be arranged within one sheet of paper because the size of the original document is too large. In such a case above, layout processing is not carried out, and the result turns out to be the same as the normal copying. Therefore, after the processing to determine the arrangement is performed, it is decided whether or not the layout processing is performed (S106).

As a result, when the layout processing is performed (S106: Y), main scanning processing is performed without carrying out the paper feeding (t1) Then, the whole original document is read in, and the image data thereof is stored (S109). This reading is performed with a resolution which allows the image data of the whole original document can be stored in the layout buffer provided in the first SDRAM 43. In addition, FIG. 9B as mentioned above is a timing diagram indicating a case in which the layout processing is performed in the automatic repeat mode.

When this main scanning is finished, the layout processing is started according to the arrangement having been decided (S108, t2). In parallel with this, the paper feed process is performed (S109), and the image data having been generated is sequentially printed, thereby performing the copying process (S110) In the paper feed process here, the paper sheet can be carried up to the actual print starting position at one stroke, at the stage (t3) where image data of print available volume is generated.

As thus described, since in the automatic repeat mode, the paper feed is performed after the reading of the original document is completed, it is possible to prevent the print paper from being subjected to a prolonged paper feeding status. Accordingly, it is possible to avoid that the print paper P takes on a shape of curled.

On the other hand, if the copying process is performed in the automatic repeat mode but the layout processing is not performed (S106: N), it is possible to perform printing concurrently with reading the image data. Therefore, the main scanning and the paper feeding are performed concurrently, and then the copying process is started (S111, t1). After the paper feed is completed, as soon as the image data is generated, printing is executed. FIG. 9C as mentioned above is a timing diagram showing a case in which the layout processing is not performed in the automatic repeat mode.

The preferred embodiments of the present invention have been explained as described so far. However, the present invention is not limited to the above embodiments, and various modifications are possible.

In the preferred embodiment as described above, it is determined whether the copy mode is the automatic repeat mode or not, as a judgment standard to decide whether or not the paper feed is performed after reading the image, without performing the parallel paper feed process (S102). However, the paper feed control which performs the paper feed after reading the image without performing the parallel paper feed process, can be applied to any other kind of copy mode, which carries out image processing such as layout processing after the reading, and a longer time is required from the start of reading image to the start of actual printing, than the processing time of the normal copying process.

Furthermore, as described above, the repeat mode includes, in addition to the automatic repeat mode, the fixed mode which arranges a predetermined set number of sheets on the print paper. When a plurality of copies of a predetermined area in the original document are arranged as they are in the fixed repeat mode, reading and printing can be performed in parallel. Therefore, parallel paper feeding process may be carried out. However, if the original document is enlarged or reduced to arrange multiple number of copies, and if it is necessary to store all the image data of the original document to perform the layout processing, it is possible to configure such that the paper feeding is performed after reading the image, similar to the case of the automatic repeat mode.

What is claimed is:

1. A multifunction machine system comprising,
a scanner section which executes a reading process to read an original document and generate image data,
a memory section in which the image data thus obtained is stored temporarily,
a printer section which executes a paper feed process to feed print paper, generates print data based on the image data and performs printing onto the print paper thus fed, thereby executing a copying process as to the original document, and
a control means which accepts a setting of a copy mode, wherein,
when the copy mode is set to perform a layout processing which arranges multiple images of the original document as a target for reading, on the print paper according to a size of the original document being detected, said control means controls so that the paper feed process is performed after the reading process is completed, and when any other copy mode is set, the control means controls so that the paper feed process is performed before the reading process is completed.

2. The multifunction machine system according to claim 1, wherein,
said scanner section performs a tentative reading process so as to determine an arrangement of the images prior to said reading process, when a copy mode is set to perform said layout processing, and
even when the copy mode is set to perform said layout processing, if it is determined, as a result of the tentative reading process, that multiple images of the original document are not allowed to be arranged on the print paper, said control section controls so that the paper feed process is performed before the reading process is completed.

3. The multifunction machine system according to claim 1, wherein,
when the copy mode is set to perform said layout processing, said control means controls so that the paper feed process is performed after the reading process is completed and at the stage where print data of print available volume is generated.

4. The multifunction machine system according to claim 3, wherein,
the paper feed process performed at the stage where the print data of print available volume is generated, carries the print paper up to a position where the printing is started.

5. The multifunction machine system according to claim 1, wherein,
when the copy mode is not set to perform said layout processing, said control means controls so that the reading process and the paper feed process are performed concurrently.

6. A paper feed control method in a multifunction machine system comprising a scanner section which executes a reading process to read an original document and generate image data, a memory section in which the image data thus obtained is stored temporarily, and a printer section which executes a paper feed process to feed print paper, generates print data based on said image data and performs printing onto the print paper thus fed, thereby executing a copying process as to said original document, said paper feed control method comprising the steps of,
accepting a setting of a copy mode,
determining whether or not the copy mode is set to perform a layout processing so that multiple images of the original document as a target for reading are arranged on the print paper based on a size of the original document being detected, and
controls so that the paper feed process is performed after the reading process is completed when the copy mode is set to perform the layout processing, and when any other copy mode is set, the paper feed process is performed before the reading process is completed.

7. A paper feed control method in a multifunction machine system, according to claim 6, wherein,
a tentative reading process is performed so as to determine an arrangement of the images prior to said reading process, when a copy mode is set to perform said layout processing, and
if it is determined, as a result of said tentative reading process, that multiple images of the original document are not allowed to be arranged on the print paper, said control section controls so that the paper feed process is performed before the reading process is completed.

8. The paper feed control method in a multifunction machine system, according to claim 6, wherein,
when the copy mode is set to perform said layout processing, said control means controls so that the paper feed process is performed after the reading process is completed and at the stage where print data of print available volume is generated.

9. The paper feed control method in a multifunction machine system, according to claim 8, wherein,
the paper feed process performed at the stage where the print data of print available volume is generated, carries the print paper up to a position where the printing is started.

10. The paper feed control method in a multifunction machine system, according to claim 6, wherein,
when the copy mode is not set to perform said layout processing, said control means controls so that the reading process and the paper feed process are performed concurrently.
